(19) United States
(12) Patent Application Publication
(10) Pub. No.: US 2025/0261162 A1
(43) Pub. Date: Aug. 14, 2025

(54) COMMUNICATION SYSTEM, COMMUNICATION CONTROL METHOD, AND CELLULAR NETWORK

(71) Applicant: TOYOTA JIDOSHA KABUSHIKI KAISHA, Toyota-shi (JP)

(72) Inventors: Hiroshi ABE, Kasukabe-shi (JP); Chunghan LEE, Yokohama-shi (JP); Lei ZHONG, Chuo-ku (JP); Toru FURUSAWA, Yokohama-shi (JP); Satoshi OMI, Edogawa-ku (JP)

(73) Assignee: TOYOTA JIDOSHA KABUSHIKI KAISHA, Toyota-shi (JP)

(21) Appl. No.: 19/042,590

(22) Filed: Jan. 31, 2025

(30) Foreign Application Priority Data
Feb. 9, 2024 (JP) 2024-018272

(51) Int. Cl. H04W 64/00; H04W 60/00; H04W 76/10

(52) U.S. Cl. CPC H04W 64/006; H04W 60/00; H04W 76/10

(57) ABSTRACT

A communication system includes a communication control device. The communication control device is configured to output an instruction to control transmission of information to each of a plurality of pieces of user equipment recognized as existing at the same position in such a manner that, concerning information to be transmitted to a specific destination from each of the plurality of pieces of UE via a cellular network, the specific destination receives information transmitted from representative UE among the plurality of pieces of UE and does not receive information from UE other than the representative UE.

### CROSS-REFERENCE TO RELATED APPLICATION

This application claims priority to Japanese Patent Application No. 2024-018272 filed on Feb. 9, 2024, incorporated herein by reference in its entirety.

### BACKGROUND

### 1. Technical Field

The present disclosure relates to a communication system, a communication control method, and a cellular network.

### 2. Description of Related Art

In related art, there is a server that collects a plurality of types of data. The plurality of types of data includes overlapping data to be acquired by a plurality of terminals. The server includes issuance means for issuing an information request that describes attributes of one or a plurality of pieces of necessary data, data reception means for receiving data to be acquired by each terminal, and plan creation means for obtaining a plan after issuance of the information request. The plan includes a timing at which a server device issues a new information request for requesting data which is not yet acquired among the plurality of types of data. The issuance means issues the information request in accordance with the plan (for example, Japanese Unexamined Patent Application Publication No. 2019-128837).

### SUMMARY

The present disclosure provides a communication system capable of reducing electric power consumption related to transmission of information, a communication control method, and a cellular network.

One of aspects of the present disclosure is a communication system. The communication system includes a communication control device. The communication control device is configured to output an instruction to control transmission of information to each of a plurality of pieces of User Equipment recognized as existing at the same position in such a manner that, concerning information to be transmitted to a specific destination from cach of the plurality of pieces of User Equipment via a cellular network, the specific destination receives information transmitted from representative User Equipment among the plurality of pieces of User Equipment and does not receive information from User Equipment other than the representative User Equipment.

The communication control device may be configured to generate a group to which the plurality of pieces of user equipment belongs based on position information of each of two or more pieces of user equipment, the position information being received from the cellular network, and select the representative user equipment from the group.

The communication system may further include the cellular network. The cellular network may be configured to acquire position information of the two or more pieces of user equipment that satisfy a specific condition among user equipment for which positions are registered in the cellular network, and transmit the position information of the two or more pieces of user equipment to the communication control device.

The specific condition may be a condition that user equipment is located in one or more specific cells.

The specific condition may be a condition that user equipment is included in a user equipment list.

The communication control device may be configured to generate the group to which specific user equipment and first user equipment belong using the position information of each of the two or more pieces of user equipment, the specific user equipment being one piece of user equipment selected from the two or more pieces of user equipment, and the first user equipment being one or more pieces of user equipment for which a distance to a position of the specific user equipment is shorter than a threshold.

The communication control device may be configured to generate the group to which specific user equipment and second user equipment belong using the position information related to the two or more pieces of user equipment, the specific user equipment being one piece of user equipment selected from the two or more pieces of user equipment, and the second user equipment being one or more pieces of user equipment for which a distance to a position of the specific user equipment is shorter than a threshold and a moving direction is recognized as the same direction as a moving direction of the specific user equipment.

The communication control device may be configured to select user equipment for which a PDU session has been established in the cellular network as the representative user equipment from the plurality of pieces of user equipment.

The communication control device may be configured to, when there are two or more pieces of user equipment for which the PDU sessions have been established, select user equipment for which a PDU session has been established first or user equipment for which a PDU session has been established last as the representative user equipment.

The communication control device may be configured to, when a change request of representative user equipment is received, execute selection of user equipment that is a substitute for the representative user equipment.

The communication system may further include the cellular network. The cellular network may be configured to establish a PDU session for transmitting the information from the representative user equipment to the specific destination and not to establish a PDU session for user equipment other than the representative user equipment among the plurality of pieces of user equipment, based on the instruction.

The communication system may further include the cellular network. The cellular network may be configured to discard packets including the information transmitted from user equipment other than the representative user equipment among the plurality of pieces of user equipment, based on the instruction.

The communication control device may be configured to supply the instruction to the specific destination. The specific destination that has obtained the instruction may be configured to transmit information indicating prohibition of transmission of the information to user equipment other than the representative user equipment among the plurality of pieces of user equipment.

The information may include an image captured at each of the plurality of pieces of user equipment.

One of the aspects of the present disclosure is a communication control method. The communication control method includes outputting, by a communication control device, an instruction to control transmission of information to each of a plurality of pieces of user equipment recognized as existing at the same position in such a manner that, concerning information to be transmitted to a specific destination from each of the plurality of pieces of user equipment via a cellular network, the specific destination receives information transmitted from representative user equipment among the plurality of pieces of user equipment and does not receive information from user equipment other than the representative user equipment.

The communication control method may further include generating, by the communication control device, a group to which the plurality of pieces of user equipment belongs based on position information of each of two or more pieces of user equipment, the position information being received from the cellular network, and selecting, by the communication control device, the representative user equipment from the group.

The communication control method may further include acquiring, by the cellular network, position information of the two or more pieces of user equipment that satisfy a specific condition from user equipment for which positions are registered in the cellular network, and transmitting, by the cellular network, the position information of the two or more pieces of user equipment to the communication control device.

Generating the group may include generating a group to which specific user equipment and first user equipment belong using the position information of each of the two or more pieces of user equipment, the specific user equipment being one piece of user equipment selected from the two or more pieces of user equipment, and the first user equipment being one or more pieces of user equipment for which a distance to a position of the specific user equipment is shorter than a threshold.

Generating the group may include generating a group to which specific user equipment and second user equipment belong using the position information related to the two or more pieces of user equipment, the specific user equipment being one piece of user equipment selected from the two or more pieces of user equipment, and the second user equipment being one or more pieces of user equipment for which a distance to a position of the specific user equipment is shorter than a threshold and a moving direction is recognized as the same direction as a moving direction of the specific user equipment.

Further, one of the aspects of the present disclosure is a cellular network. The cellular network includes a network node. The network node is configured to transmit position information of two or more pieces of user equipment that satisfy a specific condition from user equipment for which positions are registered in the cellular network, and receive an instruction to control transmission of information to each of a plurality of pieces of user equipment selected from the two or more pieces of user equipment and recognized as existing at the same position in such a manner that, concerning information to be transmitted to a specific destination from each of the plurality of pieces of user equipment via the cellular network, the specific destination receives information transmitted from representative user equipment among the plurality of pieces of user equipment and does not receive information from user equipment other than the representative user equipment.

The aspects of the present disclosure can further include the communication control device included in the communication system described above, a program for causing a computer to operate as the communication control device or a non-transitory computer-readable medium (storage medium) storing the above-described program, a network node constituting the cellular network, and the like.

According to the present disclosure, it is possible to reduce electric power consumption related to transmission of information.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 is a view illustrating a configuration example of a communication system according to an embodiment;

FIG. 2 is a view illustrating details of network nodes (components) constituting a cellular network;

FIG. 3A is a view illustrating a configuration example of an information processing device (computer) operable as a server;

FIG. 3B is a view illustrating a configuration example of an information processing device (computer) operable as a network node;

FIG. 4A is a view indicating a data structure example of a group management database (group management DB);

FIG. 4B is a view indicating a data structure example of an individual group management database (individual group management DB);

FIG. 5 is a sequence diagram indicating a first operation example in the communication system;

FIG. 6 is a flowchart indicating a processing example of a management server;

FIG. 7 is a sequence diagram indicating details of the first operation example in the communication system; and

FIG. 8 is a view for explaining a second operation example in the communication system.

### DETAILED DESCRIPTION OF EMBODIMENTS

An embodiment of a communication system, a communication control method, and a cellular network will be described below based on the drawings. The following configuration of the embodiment is an example, and the present disclosure is not limited to the configuration of the embodiment.

### Communication System

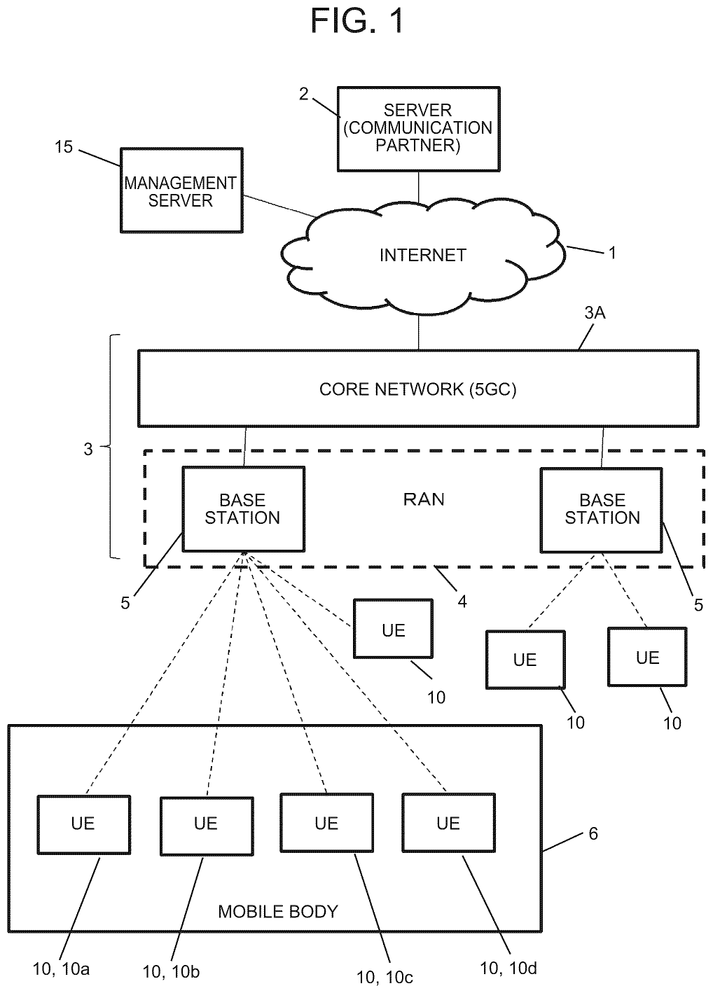

FIG. 1 is a view illustrating one example of a communication system according to the embodiment. The communication system includes the Internet 1, and a cellular network 3 connected to the Internet 1. The internet 1 is one example of a public network.

The cellular network 3 is, for example, a fourth-generation mobile communication system (4G network (LTE network)), a fifth-generation mobile communication system (5G network) or a sixth-generation mobile communication system (6G network). In the present embodiment, a case will be described where the cellular network 3 is the 5G network. The cellular network 3 includes a core network 3A, and a radio access network (RAN) 4 that is a wireless network. The RAN 4 includes one or more base stations (referred to as gNBs). The cellular network 3 is one example of a “wireless network”.

User equipment (UE) 10 is a mobile terminal (wireless terminal) capable of performing wireless communication. The UE 10 is connected to one of base stations 5, performs communication with the core network 3A via the connected base station 5 and registers a position of the UE 10. When the UE 10 performs communication with a communication partner (for example, a server 2) connected to the Internet 1, a transmission path (communication path) of a packet storing data or information is established on the RAN 4 and the core network 3A. A communication path called a wireless bearer is established between the UE 10 and the base station 5. A communication path called a packet data unit (PDU) session is established from the base station 5 to an exit of the core network 3A. A packet that has reached a termination point (UPF 11a) of the PDU session is sent out to the Internet 1 and reaches the server 2 through the Internet 1. Data or information addressed to the UE 10 from the server 2 is transmitted to the UE 10 by following the reverse route.

In FIG. 1, as indicated as UE 10a, UE 10b, UE 10c and UE 10d, in some cases, these pieces of UE are carried by one mobile body 6. For example, each member of a family of four has the UE 10 and gets on one mobile body 6. While the mobile body 6 is a vehicle, a railroad vehicle, a ship, an airplane, or the like, the mobile body 6 is not limited to the examples. The mobile body 6 may be either a manned body or an unmanned body.

A case will be assumed where a program (application) that captures an image around the UE 10 and transmits the image to the server 2 is installed in each of a plurality of pieces of UE 10 (UE 10a to 10d) placed on one mobile body 6. In this case, data of the same or similar captured images is respectively transmitted to the server 2 from the plurality of pieces of UE 10. It is assumed that the server 2 analyzes the captured images obtained from the UE 10 to obtain desired information. In this event, if the captured images obtained from the plurality of pieces of UE 10 are the same or similar, redundant analysis (redundant processing) is performed, which is useless work. Further, as a result of the plurality of pieces of UE 10 respectively transmitting the same or similar captured image data, each of the plurality of pieces of UE 10 consumes electric power. Also in the cellular network 3, as a result of transfer processing of packets including the captured image data respectively transmitted from the plurality of pieces of UE 10 being performed, electric power is consumed. In this manner, transmission of the same or similar captured images, and the like, that is, overlapping information brings useless processing at the server 2 and wasting of electric power at the UE 10 and the cellular network 3.

Thus, the communication system according to the embodiment includes a management server 15 connected to the Internet 1 as a component that solves the above problem and can avoid useless processing and wasting of electric power described above (can reduce electric power consumption). The management server 15 can perform communication with the cellular network 3 (core network 3A) and performs communication control for avoiding wasting of electric power described above.

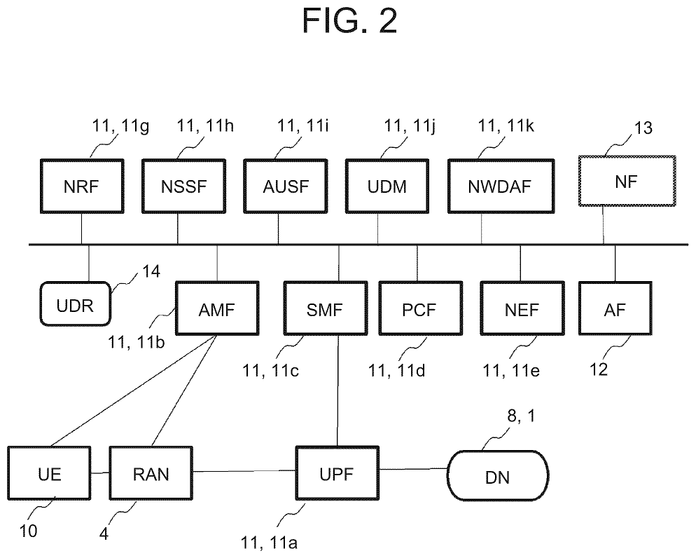

FIG. 2 is a view illustrating details of network nodes (components) constituting the cellular network 3. In FIG. 2, the UE 10 is a terminal of a user (subscriber). The RAN 4 is an access network to the core network 3A (referred to as a 5G core (5GC)). The RAN 4 is constituted with the base stations 5 (referred to as gNBs) of the number necessary for covering a communication area of the UE 10. The base stations 5 are wirelessly connected to one or more pieces of UE 10. A data network (DN) 8 is connected to a user plane (UPF 11a) of the core network 3A.

The core network 3A (5GC) is constituted with an aggregate of network nodes (components) having a predetermined function called a network function (NF). FIG. 2 illustrates the following NF 11a to NF 11k as NFs 11 that constitute the 5GC.
User plane function (UPF) 11a
Access and mobility management function (AMF) 11b
Session management function (SMF) 11c
Policy control function (PCF) 11d
Network exposure function (NEF) 11e
Network repository function (NRF) 11g
Network slice selection function (NSSF) 11h
Authentication server function (AUSF) 11i
Unified data management (UDM) 11j
Network data analytics function (NWDAF) 11k

The UPF 11a is a sole network node for a user plane in the 5GC. Nodes other than the UPF 11a are network nodes for a control plane. The UPF 11a performs routing, transfer, packet inspection and QoS processing of a user packet (packet of a user plane to be transmitted/received by the UE 10). The UPF 11a is connected to a data network (DN) 8. The DN 8 is an external network of the core network 3A and is, for example, the Internet 1.

The AMF 11b is a location storage device of the UE 10 in the core network 3A. The AMF 11b accommodates the RAN 4 (base station 5) and performs subscriber authentication control, management of positions (mobility) of the UE 10, and the like. The UDM 11j provides subscriber information or acquires, registers, deletes, or changes states of the UE 10. A UDR 14 is a database in which various kinds of information such as the subscriber information, authentication information of subscribers (UE) and position information of the UE 10 are stored.

The SMF 11c manages a protocol data unit (PDU) session and controls the UPF 11a for implementing quality of service (QoS) control and policy control. The PDU session, which is a virtual communication path for data exchange between the UE 10 and the DN 8, is established between the UE 10 and the UPF 11a.

The PCF 11d performs QoS control, policy control, billing control, and the like, under control of the SMF 11c. In the QoS control, control of communication quality such as packet priority transfer is performed. In the policy control, communication control such as QoS, whether or not packet transfer is possible, and billing based on the network or the subscriber information is performed.

The NEF 11e is a function for releasing a function (NF) or information of the 5GC to network nodes (nodes that execute an external application) existing outside the core network 3A (5GC). The external application can use the function of the 5GC via the NEF 11c.

An application function (AF) 12 is an external application of the 5GC. The management server 15 illustrated in FIG. 1 is a computer (external server) on which the AF 12 is mounted (installed). Note that the AF 12 may be disposed as an external device of the core network 3A or may be disposed as a component of the core network 3A.

The NRF 11g stores and manages information regarding the NFs (such as, for example, the AMF 11b, the SMF 11c and the UPF 11a) within the 5GC. The NRF 11g can return a plurality of candidates for the NF to an inquiry source in response to an inquiry related to the NF desired to be used. In other words, the NRF 11g can provide information indicating what kind of services is provided by which NF 11 or information indicating services that can be provided by the respective NFs 11 including the NRF 11g in response to the inquiry.

The NSSF 11h has a function of selecting a network slice to be used by a subscriber among network slices generated by network slicing. The network slice is a virtual network having specifications in accordance with application.

The AUSF 11i is a subscriber authentication server that performs subscriber authentication under control of the AMF 11b. The UDM 11j holds subscriber related information. The NWDAF 11k has a function of collecting data from each NF 11, an operations, administration and maintenance (OAM) terminal, an external device of the 5GC, and the like, and performing analysis. The NWDAF 11k is an NF that provides analysis information of the network.

The NF 13, which is a new NF, collects position information of the UE 10 in response to a request from the management server 15 or performs control related to transmission of information from the UE 10 in response to an instruction from the management server 15. Functions to be implemented by the NF 13 may be implemented by extension of one or more existing NFs 11 such as the AMF 11b, the SMF 11c, the UPF 11a or the NEF 11e as well as being implemented by implementation of the new NF as described in the present embodiment.

Each of the NFs 11a to 11k, the AF 12 and the NF 13 is implemented by one or more information processing devices (computers) executing a program. Further, the UDR 14 is a database stored in storage devices of one or more information processing devices.

When the UE 10 performs wireless connection with the base station 5, the UE 10 transmits predetermined information to the AMF 11b via the base station 5. The AMF 11b registers position information of the UE 10 in the UDR 13. When authentication of the UE 10 by the AUSF 11i is successful, the AMF 11b instructs the SMF 11c to establish a PDU session for the UE 10 to perform communication with the server 2 (communication partner). The SMF 11c selects the UPF 11a in accordance with the server 2 and instructs the selected UPF 11a to establish a PDU session. The UPF 11a establishes a PDU session between the UE 10 and the UPF 11a. Packet transfer in accordance with a packet destination address is performed between the UPF 11a and the server 2. A packet for which an address of the server 2 is set as the destination address ultimately arrives at the server 2 and is received by the server 2.

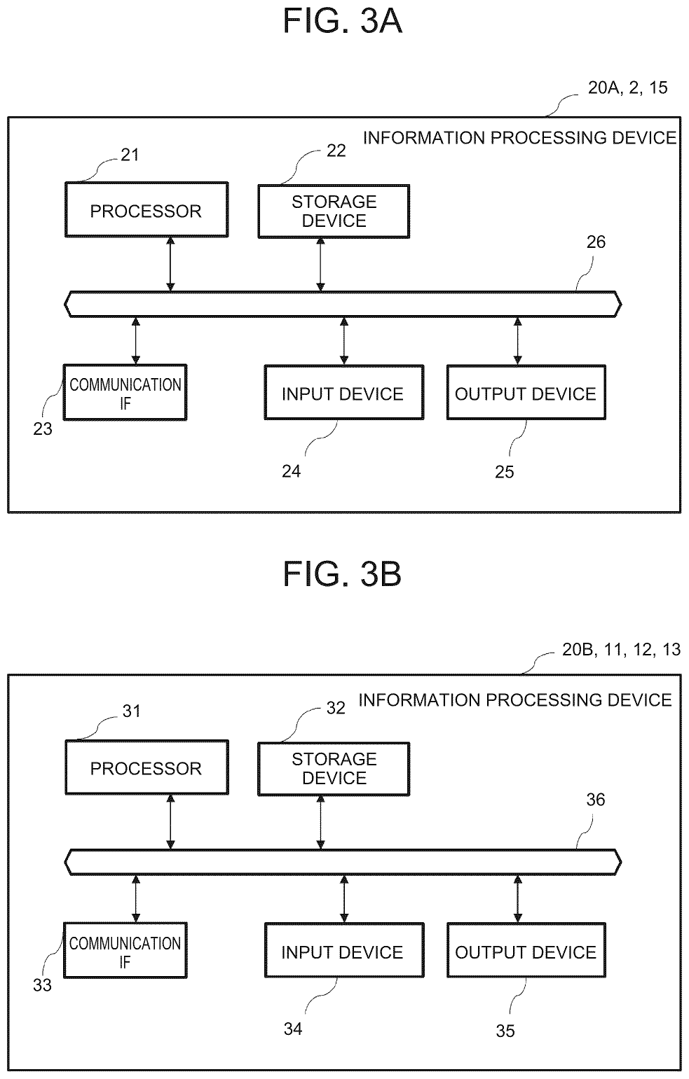

FIG. 3A is a view illustrating a configuration example of an information processing device (computer) 20A operable as the server 2 or the management server 15. FIG. 3B is a view illustrating a configuration example of an information processing device 20B operable as the NF 11, the AF 12 or the NF 13.

In FIG. 3A, the information processing device 20A is constituted with a general-purpose or dedicated computer such as a personal computer (PC), a workstation (WS) or a server machine. As one example, the information processing device 20A includes a processor 21, a storage device 22, a communication interface (communication IF) 23, an input device 24 and an output device 25 that are connected to each other via a bus 26.

The storage device 22 includes a main storage device and an auxiliary storage device. The main storage device is used as a storage area of a program and data, an area in which a program is to be loaded, a program work area, a buffer area of communication data, or the like. The main storage device is constituted with a random access memory (RAM) or a combination of the RAM and a read only memory (ROM). The auxiliary storage device is used as a storage area of data and a program. As the auxiliary storage device, for example, a non-volatile storage medium such as a hard disk, a solid state drive (SSD), a flash memory, and an electrically erasable programmable read-only memory (EEPROM) can be applied. One or more memories may be used as the storage device 22.

The communication IF 23, which is a circuit that performs processing related to communication, operates as a transmission unit and a reception unit (communication unit). The communication IF 23 is, for example, a network interface card (NIC).

The input device 24 includes a key, a button, a pointing device, a touch panel, and the like, and is used to input information. The input device 34 may include a microphone (sound input device). The output device 25 is, for example, a liquid crystal display, an organic EL display, or the like, and displays information and data. The output device 35 may include a speaker (sound output device).

The processor 21 is, for example, a central processing unit (CPU), or the like. The processor 21 performs various kinds of processing by executing various kinds of programs stored in the storage device 22.

In FIG. 3B, the information processing device 20B is constituted using a general-purpose or dedicated computer such as a personal computer (PC), a workstation (WS) or a server machine in a similar manner to the information processing device 20A. As one example, the information processing device 20B includes a processor 31, a storage device 32, a communication IF 33, an input device 34, and an output device 35 that are connected to each other via a bus 36. As the processor 31, the storage device 32, the communication IF 33, the input device 34, and the output device 35, hardware similar to those of the processor 21, the storage device 22, the communication IF 23, the input device 24, and the output device 25 can be applied. However, hardware that performs processing with different performance in accordance with required performance is employed.

Note that as the processor 21 or 31, one or a plurality of CPUs may be employed, or a multicore CPU may be employed. At least part of processing to be performed by the CPU may be performed by a processor other than the CPU like a digital signal processor (DSP) or a graphical processing unit (GPU). Further, at least part of processing to be performed by the CPU may be performed by a dedicated or general-purpose integrated circuit (hardware). The integrated circuit includes an application specific integrated circuit (ASIC), a field programmable gate array (FPGA), and the like. Alternatively, at least part of processing to be performed by the CPU may be executed by a combination of the processor and the integrated circuit. The combination is, for example, referred to as a microcontroller (MCU), a system-on-a-chip (SoC), a system LSI, a chipset, or the like. Each of the above processor 31, the integrated circuit and the combination is one example of a circuit (circuitry).

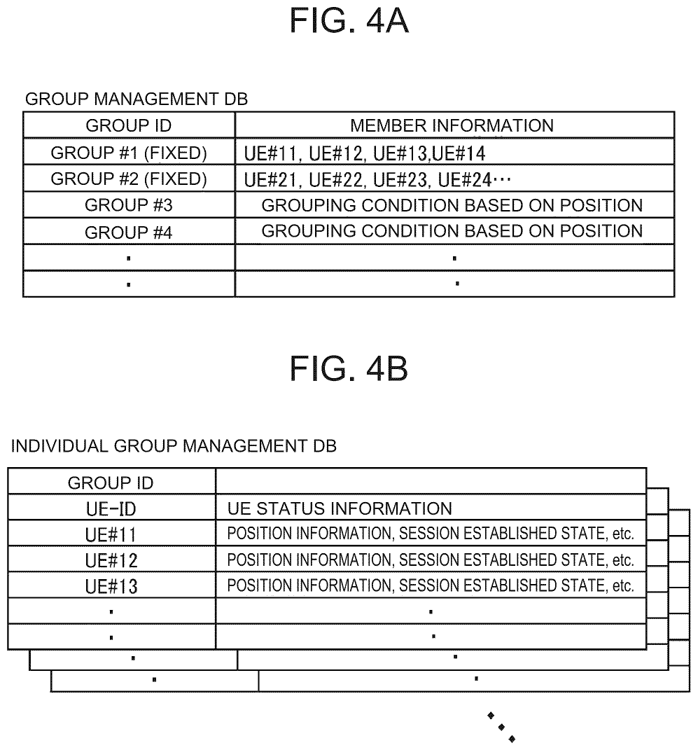

FIG. 4A is a view indicating a data structure example of a group management database (DB), and FIG. 4B is a view indicating a data structure example of an individual group management DB. The group management DB and the individual group management DB are stored in, for example, the storage device 22 of the information processing device 20A that operates as the management server 15 or a storage device (external storage) on a network that can be accessed by the management server 15.

In FIG. 4A, the group management DB has a table structure including one or more entries provided for each group ID (group identifier). The entries include a group ID and information (member information) indicating a member corresponding to the group ID. The member information includes, for example, identification information (UE-ID) of each piece of UE 10 that is a member of the group. The UE-ID is, for example, contractor information that specifies a subscriber stored in a subscriber identity module (SIM) card of the UE 10. However, as the UE-ID, any information that can uniquely identify the UE 10 can be employed. A plurality of UE-IDs included in the member information includes, for example, UE-IDs of the UE 10 of family members, UE-IDs of UE 10 of a plurality of people (such as employees and group members) who gets on a predetermined mobile body 6 at determined time, and the like. However, the plurality of UE-IDs may be arbitrarily combined.

The member information may be information indicating a condition (referred to as a grouping condition) of group generation based on positions. The grouping condition becomes a criterion (filtering criterion) for selecting (filtering) the UE 10 in the core network 3A.

The grouping condition is, for example, a condition that the UE 10 is located in the same cell (connected to the same base station 5). The base station 5 may be a fixed base station or a mobile base station mounted on the mobile body 6. The cell (base station) is specified using a cell ID or identification information (BS-ID) of the base station 5 other than the cell ID. The grouping condition may be a condition that the UE 10 exists in a circular area having a predetermined radius centering around a certain position coordinate. Further, the grouping condition may be a condition that a distance to one piece of UE 10 (referred to as specific UE) selected from two or more pieces of UE 10 is equal to or less than a threshold (or less than a threshold). A selection method of the specific UE is not limited. The specific UE may be randomly selected, may be selected in order of connection to the base station 5, may be selected in the inverse order of connection or may be selected in descending order of priority determined in advance.

The individual group management DB includes, for example, one or more tables prepared for each group ID. Each table includes one or more entries prepared for each identification information (UE-ID) of the UE 10. The entries store UE-IDs and status information corresponding to the UE-IDs. The UE-IDs are identification information of the UE 10 and may be any information as long as the information can uniquely identify the UE 10. The UE status information includes position information of the UE 10, and information indicating whether a PDU session related to the UE 10 is established (established or not established). The position information may be identification information of a cell such as a cell ID (information indirectly indicating a position of the UE 10) or may be information indicating a position coordinate on which the UE 10 exists (information directly indicating the position). The UE status information may include information indicating a moving direction of the UE 10.

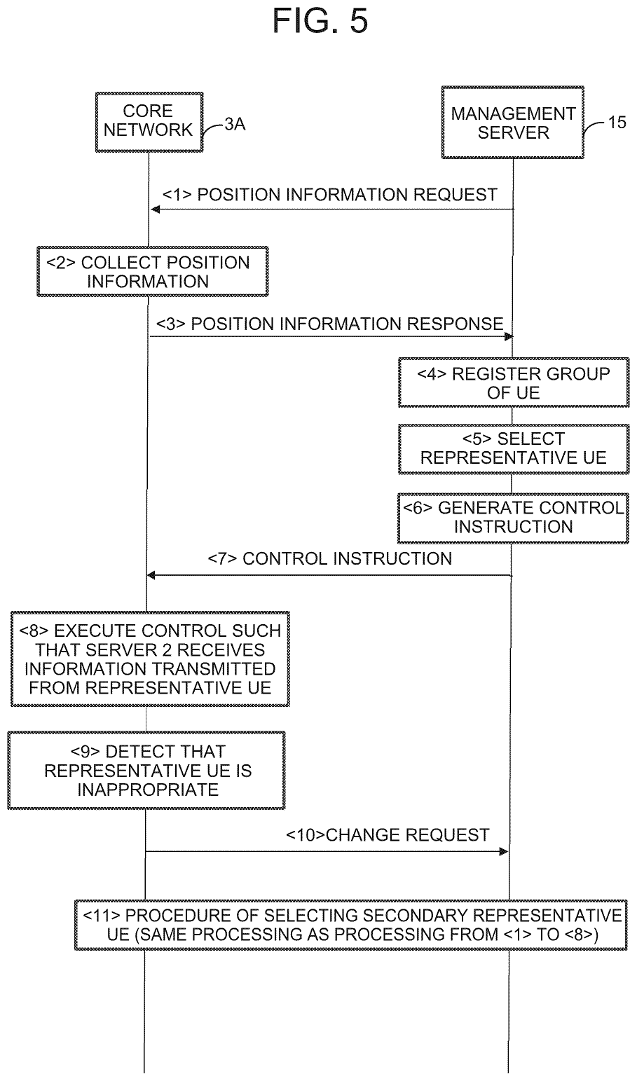

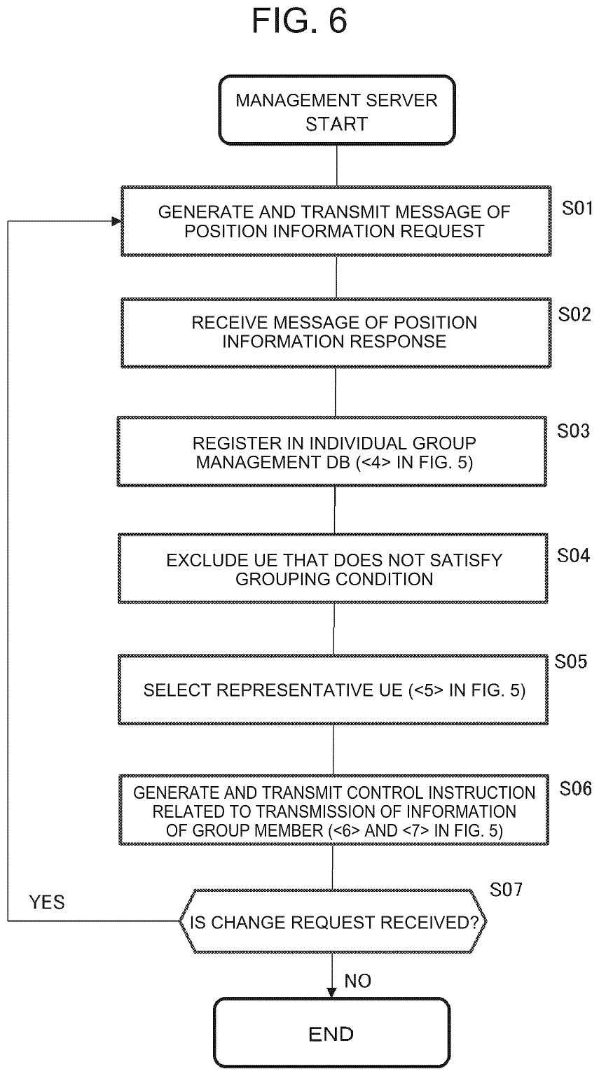

FIG. 5 is a sequence diagram indicating a first operation example in the communication system (FIG. 1). FIG. 6 is a flowchart indicating a processing example of the management server 15. The processing indicated in FIG. 6 is performed by the management server 15, that is, the processor 21 that executes the AF 12 mounted on the information processing device 20A that operates as the management server 15.

In FIG. 5, the management server 15 extracts one entry from the group management DB (FIG. 4A) and generates a message of a position information request including the group ID and the member information in the extracted entry (step S01 in FIG. 6). The message of the position information request is transmitted from the management server 15 to the core network 3A (<1> in FIG. 5).

The core network 3A collects position information (<2> in FIG. 5). In other words, the core network 3A collects (acquires) position information of each of the UE 10 having UE-IDs included in the member information or position information of one or more pieces of UE 10 that satisfy the grouping condition (filtering criterion of the UE 10) from the UDR 13, or the like. The acquired position information is included in a message of a position information response to the message of the position information request and transmitted from the core network 3A to the management server 15.

The management server 15 receives the message of the position information response (step S02 in FIG. 6). Then, the management server 15 registers a group of the UE 10 (<4> in FIG. 5). The message of the position information response received from the core network 3A includes the group ID, and the UE-ID, the position information, and information indicating a PDU session state (established, not established, established time) related to each of the two or more pieces of UE 10 according to the member information.

The management server 15 registers the UE-IDs, the position information and the PDU session states in a table (group table) corresponding to the group ID in the individual group management DB (step S03 in FIG. 6). The group registered in the individual group management DB becomes a target for which transmission of information is to be controlled.

Here, when the member information is a plurality of UE-IDs, grouping may be performed again (step S04 in FIG. 6). For example, when position information of the UE 10 that does not satisfy the grouping condition based on the position is included in the position information response, the management server 15 excludes the UE 10 having such position information from the group table. This is because the UE 10 that does not satisfy the grouping condition does not correspond to UE recognized as existing at the same position.

The management server 15 selects representative UE (<5> in FIG. 5). In other words, the management server 15 selects (determines) one piece of UE 10 that matches a selection condition as the representative UE from the plurality of pieces of UE 10 registered in the table for which the group has been registered (step S05 in FIG. 6). As the selection condition, the UE 10 for which the PDU session has been established is selected in preference to the UE 10 for which the PDU session has not been established. When there are two or more pieces of UE 10 for which the PDU sessions have been established, the UE 10 for which the PDU session has been established at the earliest time or the UE 10 for which the PDU session has been established at the latest time is selected as the representative UE. However, in some cases, UE other than the UE 10 for which the PDU session has been established at the earliest time or the latest time may be selected as the representative UE. When there is no UE 10 for which the PDU session has been established, the management server 15 can select the representative UE according to a rule determined in advance.

The management server 15 generates a control instruction (<6> in FIG. 5). In other words, the management server 15 generates and transmits a message of the control instruction related to transmission of information of the respective pieces of UE 10 that are group members (step S06 in FIG. 6). The message of the control instruction includes at least UE-IDs of the group members and a UE-ID of the representative UE.

The message of the control instruction is transmitted from the management server 15 to the core network 3A (<7> in FIG. 5). When the core network 3A receives the control instruction, the core network 3A executes control such that the server 2 receives information transmitted from the representative UE among the group members and the server 2 does not receive information from the UE 10 other than the representative UE (<8> in FIG. 5).

Then, the core network 3A performs monitoring related to the representative UE and when the core network 3A does not receive information from the representative UE continuously for a predetermined period, or when the representative UE performs handover, the core network 3A detects that the UE 10 that is the representative UE is inappropriate as the representative UE (<9> in FIG. 5). In this case, the core network 3A transmits a message of a change request of the representative UE to the management server 15 (<11> in FIG. 5).

When the management server 15 receives the change request (S07 in FIG. 6: Yes), the management server 15 performs procedure of selecting secondary representative UE (<10> in FIG. 5). In other words, the processing in FIG. 6 is returned to step S01, and the management server 15 performs processing from step S01 to S06. By this means, processing that is the same as the processing from <1> to <8> in FIG. 5 is performed. However, the UE 10 that is detected as inappropriate as the representative UE is excluded from targets to be registered in the group table. In this manner, when the representative UE is inappropriate, transmission of information may be controlled while secondary (sub) representative UE is selected. However, when primary representative UE and secondary representative UE are selected in selection of the representative UE in <5> in FIG. 5, and the primary representative UE is detected as inappropriate, processing of switching the representative UE to the secondary representative UE may be performed in the core network 3A

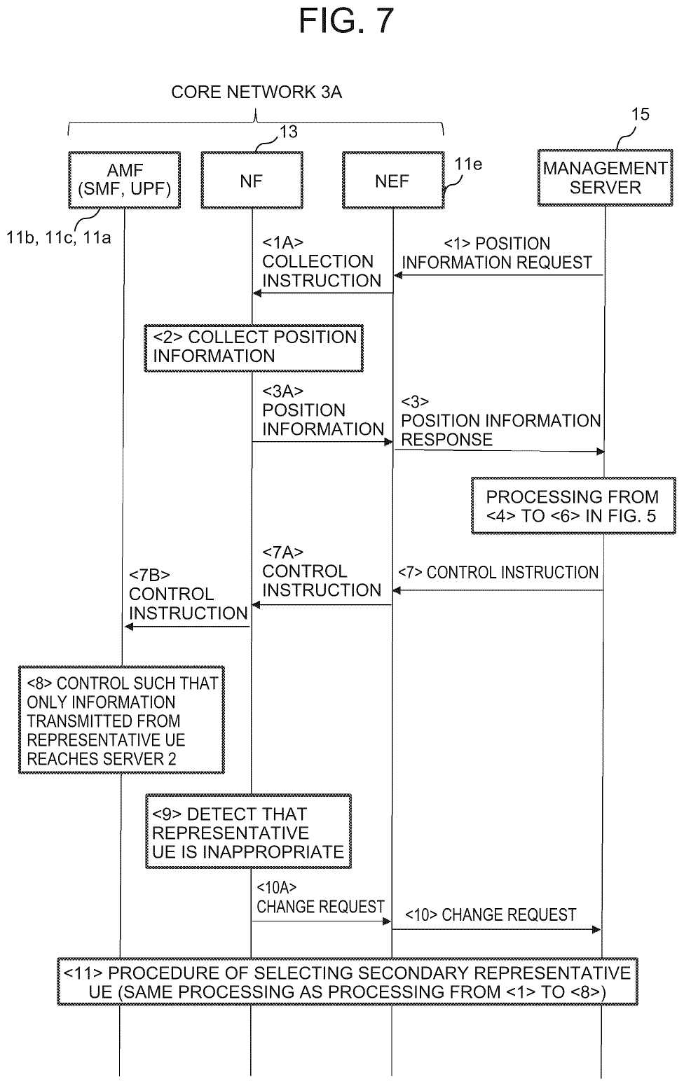

FIG. 7 is a sequence diagram indicating details of the first operation example in the communication system and indicates a detailed operation example within the core network 3A. In the example indicated in FIG. 7, the position information request from the management server 15 is received at the NEF 11e (information processing device 20B that operates as the NEF 11e) of the core network 3A (<1> in FIG. 7). The NEF 11e transmits a collection instruction of position information according to the position information request to the NF 13 (information processing device 20B that operates as the NF 13) (<1A> in FIG. 7).

The NF 13 performs processing similar to the position information collection indicated in <2> in FIG. 5 (<2> in FIG. 7). The NF 13 transmits the collected position information to the NEF 11e (<3A> in FIG. 7), and the NEF 11e generates a message of a position information response and transmits the message to the management server 15 (<3> in FIG. 7).

The management server 15 performs processing similar to the processing from <4> to <6> in FIG. 5 and transmits the control instruction to the NEF 11e of the core network 3A (<7> in FIG. 7). The NEF 11e transmits the control instruction to the NF 13 (<7A> in FIG. 7).

The NF 13 transmits the control instruction to at least one of the AMF 11b, the SMF 11c or the UPF 11a (information processing device 20B that operates as at least one of the AMF 11b, the SMF 11c or the UPF 11a) (<7B> in FIG. 7). At least one of the AMF 11b or the SMF 11c controls transmission of information in such a manner that only information transmitted from the representative UE reaches the server 2 (<8> in FIG. 7).

For example, when the control instruction is supplied to the AMF 11b, the AMF 11b performs operation of establishing or maintaining an established state of a PDU session for transmitting information (such as image data obtained by capturing an image by the UE 10) to the server 2 in coordination with the SMF 11c regarding the representative UE. On the other hand, the AMF 11b performs processing of rejecting establishment of the PDU session for transmitting information to the server 2 or ending the established PDU session regarding the UE 10 that is members other than the representative UE. By this means, only the representative UE among the members is put into a state where information can be transmitted to the server 2.

When the control instruction is supplied to the SMF 11c, the SMF 11c is put into a state where the SMF 11c accepts a request for establishment of a PDU session related to the representative UE from the AMF 11b and rejects requests for establishment of PDU sessions related to members other than the representative UE. Also, by this means, only the representative UE among the members is put into a state where information can be transmitted to the server 2.

Alternatively, the NF 13 can also transmit the control instruction to the UPF 11a. In this case, the UPF 11a is put into a state where the UPF 11a establishes a PDU session related to the representative UE in accordance with an instruction from the SMF 11c but does not establish PDU sessions related to members other than the representative UE. Also, by this means, only the representative UE among the members is put into a state where information can be transmitted to the server 2.

Alternatively, the UPF 11a may be put into a state where the UPF 11a performs the following operation. The UPF 11a establishes a PDU session related to the UE 10 of each member. However, while information from the representative UE is transferred to the server 2, information from members other than the representative UE is discarded (not transferred to the server 2). By this means, the state becomes a state where only information from the representative UE reaches the server 2.

Note that when the control instruction is supplied to the UPF 11a, the following configuration can be also employed. The UPF 11a communicates with an application for information transmission installed in the UE 10 of the members or an application that controls the application for information transmission via the RAN 4. In the communication, the UPF 11a instructs the representative UE to allow transmission of information and instructs members other than the representative UE to prohibit transmission of information. Also, by this means, only the representative UE can transmit information to the server 2.

According to the first operation example, as a result of the PDU session of the representative UE being established, and PDU sessions of members other than the representative UE being not established, only the representative UE can transmit information (such as image data) to the server 2. By this means, members other than the representative UE do not transmit information to the server 2, which reduces electric power consumption of the members. Further, in the cellular network 3, processing of transferring packets transmitted from the members other than the representative UE is not performed, so that electric power consumption in the cellular network 3 (the RAN 4 and the core network 3A) is reduced.

Only information (for example, captured image data) from the representative UE reaches the server 2, which avoids processing from being performed on the same or similar information (overlapping data) at the server 2. This reduces processing load and electric power consumption of the server 2. In a configuration where the UPF 11a discards information from members other than the representative UE, processing of the UPF 11a transmitting information from each member to the server 2 is avoided, so that electric power consumption in the core network 3A is reduced.

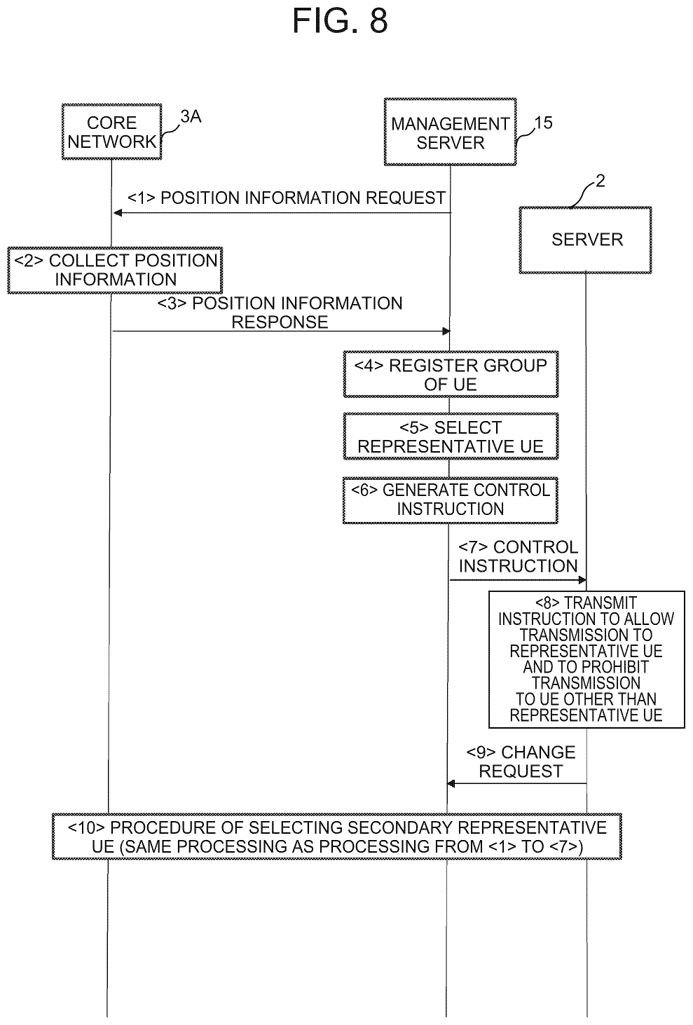

FIG. 8 is a view for explaining a second operation example in the communication system. Processing from <1> to <6> in FIG. 8 is the same as the processing from <1> to <6> in FIG. 5, and thus, description will be omitted. In <7> in FIG. 8, the management server 15 transmits the control instruction to the server 2 via the Internet 1.

The server 2 (the information processing device 20A that operates as the server 2) that has received the control instruction transmits an instruction to prohibit (stop) transmission of information to the UE 10 of the members other than the representative UE in accordance with the control instruction (<8> in FIG. 8). By this means, the members other than the representative UE do not transmit information to the server 2. Also, by this means, electric power consumption of the UE 10 other than the representative UE and the cellular network can be reduced.

When the server 2 detects that the representative UE is inappropriate as a result of information being not received from the representative UE continuously for a predetermined period, the server 2 transmits a message of a change request of the representative UE to the management server 15 (<9> in FIG. 8). The management server 15 executes procedure (processing similar to the processing from <1> to <7> in FIG. 8) of selecting the secondary representative UE in response to the change request (<10> in FIG. 8).

The communication system according to the embodiment includes the management server 15. The management server 15 can output (transmit) an instruction regarding information to be transmitted to the server 2 from each piece of the UE 10 that is a group member via the cellular network 3. The management server 15 is one example of the communication control device of the present disclosure. The UE 10 that is the group member is one example of a plurality of pieces of UE recognized as existing at the same position. The server 2 is one example of a specific destination of the present disclosure. The instruction is an instruction to control transmission of information to each member in such a manner that the server 2 (specific destination) receives information transmitted from the representative UE among the members (the plurality of pieces of UE) and does not receive information from members other than the representative UE.

As a result of control being performed in such a manner that information from the representative UE is received by the server 2, it is possible to reduce processing load and electric power consumption of the UE of the members other than the representative UE, the cellular network and the server 2.

In the embodiment, the management server 15 (communication control device) can generate a group to which the plurality of pieces of UE belongs and select the representative UE from the group based on position information of each of two or more pieces of UE 10 received from the cellular network 3 (<4> and <5> in FIGS. 5, S03 to S05 in FIG. 6).

In the embodiment, the cellular network 3 included in the communication system can acquire position information of two or more pieces of UE 10 that satisfy a grouping condition (corresponding to a specific condition) from the UE 10 for which positions are registered in the cellular network 3 (<2> in FIG. 5). Further, the cellular network 3 can transmit the position information of the two or more pieces of UE to the management server 15 (communication control device) (<3> in FIG. 5).

The grouping condition (specific condition) may be, for example, a condition that the UE is located in one or more specific cells. Further, the grouping condition may be a condition that the UE 10 is included in the member information. The member information is one example of a UE list of the present disclosure.

In group generation (group registration, S03 and S04 in FIG. 6), the management server 15 (communication control device) can generate a group to which one piece of UE 10 (specific UE) and one or more pieces of UE 10 (referred to as first UE) belong using the grouping condition and the position information of each of the two or more pieces of UE 10, the specific UE being one piece of UE selected from the two or more pieces of UE 10, and the first UE 10 being one or more pieces of UE for which a distance to a position of the specific UE is shorter than a threshold.

In group generation (group registration, S03 and S04 in FIG. 6), the management server 15 (communication control device) can generate a group to which specific UE and one or more pieces of UE 10 (referred to as second UE) belong using the grouping condition and the position information related to the two or more pieces of UE 10, the specific UE being one piece of UE selected from the two or more pieces of UE 10, and the second UE 10 being one or more pieces of UE for which a distance to the position of the specific UE 10 is shorter than the threshold and a moving direction is recognized as the same direction as a moving direction of the specific UE 10.

The management server 15 (communication control device) can select UE 10 for which a PDU session has been established in the cellular network 3 as the representative UE among the UE 10 of the group members (<5> in FIG. 5. S05 in FIG. 6).

When the group includes two or more pieces of UE 10 for which the PDU sessions have been established, the management server 15 (communication control device) can select the UE 10 for which the PDU session has been established first (for which establishment time of the PDU session is the earliest) or the UE 10 for which the PDU session has been established last (for which establishment time of the PDU session is the latest) as the representative UE (<5> in FIG. 5, S05 in FIG. 6).

When the change request of the representative UE is received, the management server 15 (communication control device) can execute selection of UE that is a substitute for the representative UE, that is, secondary representative UE (<11> in FIG. 5).

The cellular network 3 (the AMF 11b, the SMF 11c or the UPF 11a) included in the communication system can employ a configuration in which a PDU session for transmitting information from the representative UE to the server 2 is established, and PDU sessions for the UE 10 of the members other than the representative UE are not established based on the control instruction (<8> in FIG. 5, <8> in FIG. 7).

The cellular network 3 included in the communication system can employ a configuration in which packets including information transmitted from UE other than the representative UE are discarded based on the control instruction (<8> in FIG. 5, <8> in FIG. 7).

The management server 15 (communication control device) supplies (transmits) the control instruction to the server 2, and the server 2 that has obtained the control instruction can transmit information indicating prohibition of transmission of information (instruction to prohibit transmission of information) to the UE 10 of the members other than the representative UE (<8> in FIG. 8).

Information addressed to the server 2 can include data of images respectively captured by the UE 10 of the members. However, a type of the information is not limited to an image and may be information recognized as the same or similar (overlapping information) in the server 2.

The cellular network 3 according to the embodiment can include a network node (NEF 11e) that transmits position information of two or more pieces of UE 10 that satisfy a specific condition (grouping condition) among the UE 10 for which positions are registered in the cellular network 3 and receives an instruction to control transmission of information to each of a plurality of pieces of UE 10 selected from the two or more pieces of UE 10 and recognized as existing at the same position in such a manner that, concerning information to be transmitted to the server 2 from each of the plurality of pieces of UE 10 via the cellular network 3, the server 2 receives information transmitted from the representative UE among the plurality of pieces of UE 10 and does not receive information from UE other than the representative UE. The network node may be the NF 11 other than the NEF 11e. The network node may be one or more NFs 11. The network node may be either a new NF 11 or an extended existing NF 11.

The above-described embodiment and modifications are merely one example, and the present disclosure can be changed as appropriate and implemented within a range not deviating from the gist of the present disclosure. The processing and means described in the present disclosure can be freely combined and implemented unless technical consistency arises.

Processing described as being performed by one device may be shared and executed by a plurality of devices. Alternatively, processing described as being performed by different devices may be executed by one device. In a computer system, what kind of hardware component (server component) is used to implement each function can be flexibly changed.

The present disclosure can be implemented by a computer program implementing the functions described in the above embodiment being supplied to a computer, and one or more processors of the computer reading out and executing the program. Such a computer program may be provided to a computer by a non-transitory computer-readable storage medium that can be connected to a system bus of the computer or may be provided to the computer via a network. The non-transitory computer-readable storage medium includes, for example, an arbitrary type of disk such as a magnetic disk (such as a floppy (registered trademark) disk and a hard disk drive (HDD)) and an optical disk (such as a CD-ROM, a DVD disk and a Blu-ray disk), and an arbitrary type of medium appropriate for storing an electronic command, such as a read only memory (ROM), a random access memory (RAM), an EPROM, an EEPROM, a magnetic card, a flash memory and an optical card.

What is claimed is:

1. A communication system comprising,
a communication control device configured to output an instruction to control transmission of information to each of a plurality of pieces of user equipment recognized as existing at the same position in such a manner that, concerning information to be transmitted to a specific destination from each of the plurality of pieces of user equipment via a cellular network, the specific destination receives information transmitted from representative user equipment among the plurality of pieces of user equipment and does not receive information from user equipment other than the representative user equipment.

2. The communication system according to claim 1,
wherein the communication control device is configured to:
generate a group to which the plurality of pieces of user equipment belongs based on position information of each of two or more pieces of user equipment, the position information being received from the cellular network; and
select the representative user equipment from the group.

3. The communication system according to claim 2, wherein
the communication system further includes the cellular network, and
the cellular network is configured to:
acquire position information of the two or more pieces of user equipment that satisfy a specific condition among user equipment for which positions are registered in the cellular network; and
transmit the position information of the two or more pieces of user equipment to the communication control device.

4. The communication system according to claim 3, wherein the specific condition is a condition that user equipment is located in one or more specific cells.

5. The communication system according to claim 3, wherein the specific condition is a condition that user equipment is included in a user equipment list.

6. The communication system according to claim 2, wherein the communication control device is configured to generate the group to which specific user equipment and first user equipment belong using the position information of each of the two or more pieces of user equipment, the specific user equipment being one piece of user equipment selected from the two or more pieces of user equipment, and the first user equipment being one or more pieces of user equipment for which a distance to a position of the specific user equipment is shorter than a threshold.

7. The communication system according to claim 2, wherein the communication control device is configured to generate the group to which specific user equipment and second user equipment belong using the position information related to the two or more pieces of user equipment, the specific user equipment being one piece of user equipment selected from the two or more pieces of user equipment, and the second user equipment being one or more pieces of user equipment for which a distance to a position of the specific user equipment is shorter than a threshold and a moving direction is recognized as the same direction as a moving direction of the specific user equipment.

8. The communication system according to claim 2, wherein the communication control device is configured to select user equipment for which a PDU session has been established in the cellular network as the representative user equipment from the plurality of pieces of user equipment.

9. The communication system according to claim 8, wherein when there are two or more pieces of user equipment for which the PDU sessions have been established, the communication control device is configured to select user equipment for which a PDU session has been established first or user equipment for which a PDU session has been established last as the representative user equipment.

10. The communication system according to claim 2, wherein when a change request of representative user equipment is received, the communication control device is configured to execute selection of user equipment that is a substitute for the representative user equipment.

11. The communication system according to claim 1, wherein
the communication system further includes the cellular network, and
the cellular network is configured to establish a PDU session for transmitting the information from the representative user equipment to the specific destination and not to establish a PDU session for user equipment other than the representative user equipment among the plurality of pieces of user equipment, based on the instruction.

12. The communication system according to claim 1, wherein
the communication system further includes the cellular network, and
the cellular network is configured to discard packets including the information transmitted from user equipment other than the representative user equipment among the plurality of pieces of user equipment, based on the instruction.

13. The communication system according to claim 1, wherein
the communication control device is configured to supply the instruction to the specific destination, and
the specific destination that has obtained the instruction is configured to transmit information indicating prohibition of transmission of the information to user equipment other than the representative user equipment among the plurality of pieces of user equipment.

14. The communication system according to claim 1, wherein the information includes an image captured at each of the plurality of pieces of user equipment.

15. A communication control method comprising,
outputting, by a communication control device, an instruction to control transmission of information to each of a plurality of pieces of user equipment recognized as existing at the same position in such a manner that, concerning information to be transmitted to a specific destination from each of the plurality of pieces of user equipment via a cellular network, the specific destination receives information transmitted from representative user equipment among the plurality of pieces of user equipment and does not receive information from user equipment other than the representative user equipment.

16. The communication control method according to claim 15, further comprising:
generating, by the communication control device, a group to which the plurality of pieces of user equipment belongs based on position information of each of two or more pieces of user equipment, the position information being received from the cellular network; and
selecting, by the communication control device, the representative user equipment from the group.

17. The communication control method according to claim 16, further comprising:
acquiring, by the cellular network, position information of the two or more pieces of user equipment that satisfy a specific condition from user equipment for which positions are registered in the cellular network; and
transmitting, by the cellular network, the position information of the two or more pieces of user equipment to the communication control device.

18. The communication control method according to claim 16, wherein generating the group includes generating a group to which specific user equipment and first user equipment belong using the position information of each of the two or more pieces of user equipment, the specific user equipment being one piece of user equipment selected from the two or more pieces of user equipment, and the first user equipment being one or more pieces of user equipment for which a distance to a position of the specific user equipment is shorter than a threshold.

19. The communication control method according to claim 16, wherein generating the group includes generating a group to which specific user equipment and second user equipment belong using the position information related to the two or more pieces of user equipment, the specific user equipment being one piece of user equipment selected from the two or more pieces of user equipment, and the second user equipment being one or more pieces of user equipment for which a distance to a position of the specific user equipment is shorter than a threshold and a moving direction is recognized as the same direction as a moving direction of the specific user equipment.

20. A cellular network comprising,
a network node configured to:
transmit position information of two or more pieces of user equipment that satisfy a specific condition from user equipment for which positions are registered in the cellular network; and
receive an instruction to control transmission of information to each of a plurality of pieces of user equipment selected from the two or more pieces of user equipment and recognized as existing at the same position in such a manner that, concerning information to be transmitted to a specific destination from each of the plurality of pieces of user equipment via the cellular network, the specific destination receives information transmitted from representative user equipment among the plurality of pieces of user equipment and does not receive information from user equipment other than the representative user equipment.
